(19) United States
(12) Patent Application Publication
(10) Pub. No.: US 2020/0016939 A1
(43) Pub. Date: Jan. 16, 2020

(54) TIRE WITH AN INSERT HAVING A HIGH MODULUS

(71) Applicant: COMPAGNIE GENERALE DES ETABLISSEMENTS MICHELIN, Clermont-Ferrand (FR)

(72) Inventor: JOSÉ MERINO LOPEZ, CLERMONT-FERRAND (FR)

(21) Appl. No.: 16/336,225

(22) PCT Filed: Sep. 21, 2017
(86) PCT No.: PCT/IB2017/055717

§ 371 Date: Mar. 25, 2019

(30) Foreign Application Priority Data
Sep. 25, 2016 (FR) 16/70547

(51) Int. Cl. B60C 13/00; B60C 1/00; B60C 5/14

(52) U.S. Cl. CPC B60C 13/002; B60C 1/0025; B60C 5/14; B60C 2013/007; B60C 2001/0033; B60C 2013/006; B60C 2200/065; B60C 1/0008

(57) ABSTRACT

A tire (1) includes sidewalls (2), a crown region (3) provided with a tread (4), a reinforcing structure (5) extending between the sidewalls and passing via the crown region, at least a portion of one of the sidewalls and/or of the crown comprising an insert (6) comprising a first elastomer composition serving as a matrix, within which a second elastomer composition derived from recycled tires is distributed substantially uniformly, the modulus of the first composition being at least 10% greater than the modulus of the second composition, and the proportion of second composition being greater than or equal to 40%.

### TECHNICAL FIELD OF THE INVENTION

The present invention relates to a tyre. It relates more particularly to a tyre composed of a high proportion of powder from recycled tyres.

### PRIOR ART

The field of tyres is subject to numerous requirements. This is because tyres must offer guarantees of safety, durability and good performance properties. Tyres are also subject to significant external attacks such as from potholes or else pavements. It is therefore important for them to have high strength.

Moreover, in addition to the above requirements, environmental concerns have led to the development of more environmentally friendly products at the present time. The use of a powder of rubber compound from recycled tyres is especially known. This powder consists of residues of worn tyres (or new tyres with manufacturing defects) which are disassembled using specially designed machines, making it possible to recover the vulcanized rubber materials and to extract the textile and metal reinforcers. The extracted rubber materials are then ground to make a powder therefrom (sometimes referred to as “crumb rubber” because of the very small size of the particles obtained). A powder of this type may be used in numerous applications where it is desired to incorporate recycled materials, whether for economic and/or environmental reasons.

Document KR2009068400 describes the rubber composition of a tyre inner liner. This inner liner is a mixture of halobutyl rubber, of natural rubber, of recycled butyl rubber, of carbon black and a small amount of waste tyre powder.

Document EP2104710 describes a tyre tread composed of a powder of xanthan gum in a proportion of 10 to 40 phr.

Generally speaking, for tyres, the use of powders of recycled materials remains limited to low proportions, mainly so as not to adversely affect the performance properties of the tyre.

The invention provides various technical means for remedying these various drawbacks.

### SUMMARY OF THE INVENTION

Firstly, a first object of the invention consists in enabling a large-scale use of residues from tyres that have reached the end of their life.

Another object of the invention consists in decreasing the raw material costs of tyres while ensuring that the level of quality of the products manufactured is maintained.

Another object of the invention consists in providing a tyre composed to a large extent of materials derived from tyres at the end of their life, without losing the performance of the tyre.

Yet another object of the invention consists in decreasing the raw material costs of tyres while making it possible to reduce the risks of cracking by chemical and/or UV attack.

Another object consists in providing a tyre with reduced cost.

To this end, the invention provides a tyre with sidewalls, a crown region provided with a tread, a reinforcing structure extending between the sidewalls and passing via the crown region, at least a portion of one of the sidewalls and/or of the crown comprises an insert comprising a first elastomer composition serving as a matrix, within which a second elastomer composition derived from recycled tyres is distributed substantially uniformly, the dynamic shear modulus G* of the first composition being at least 10% greater than the mean dynamic shear modulus G* of the second composition, and the proportion of second composition being greater than or equal to 20% of the mass of the said insert.

Such an architecture, used on an industrial scale to manufacture thousands of products, makes it possible to use large amounts of recycled products. This approach is environmentally friendly on the one hand as it reduces the amount of waste, and on the other as it saves on new-material resources. The difference in modulus between the two compositions used allows the matrix to play an effective role in cohesion, contributing to the robustness and durability of the whole. The proportion of the compositions is preferably determined according to the mass of the compositions. Specifically, measuring the allocation of proportions using the volumes of the compositions would be a more painstaking task because of the often complex volumes to be taken into consideration. However, the density of the elastomer compositions of the new products in the tyre and the density of the blends of elastomer material derived from recycled tyres are very similar. As a result, the compound proportions obtained by measuring volume or mass are very similar.

Advantageously, the proportion of second composition is greater than or equal to 25% and more preferentially greater than or equal to 40%.

Advantageously, the dynamic shear modulus G* of the first composition is comprised between 110% and 600% of the dynamic shear modulus G* of the second composition, and more preferentially between 120% and 250% of the dynamic shear modulus G* of the second composition.

According to one advantageous embodiment, the dynamic shear modulus G* of the first composition is comprised between 1.2 MPa and 10 MPa, and preferentially between 1.4 MPa and 3 MPa

According to one exemplary embodiment, the proportion of second composition is greater than 60% and more preferentially greater than 80%.

According to one advantageous embodiment, the first elastomer composition has a high content of antioxidants, such as for example 6PPD, at a content advantageously greater than 2 phr.

Advantageously, the first composition is a rubber composition.

According to another advantageous embodiment, the second elastomer composition has a particle size distribution less than or equal to 1 mm and preferentially less than or equal to 0.5 mm and even more preferentially less than or equal to 0.2 mm of mean diameter of each of the particles. Such a particle size distribution makes it possible to prepare a well-dosed hybrid compound with an excellent distribution of the powder in the matrix.

According to one advantageous embodiment, the insert is positioned in the portion of the sidewalls axially on the outside of the reinforcing structure.

Such an insert is advantageously covered axially on the outside by a protective layer, such as a layer of elastomer composition or a two-way stretch fabric. Such a protective layer (of elastomeric nature or made of fabric) affords additional protection against chemical attacks, oxidation, UV rays, which might be capable of causing cracking on the insert. Fabric offers particularly advantageous mechanical properties of strength and durability.

In the latter instance, the two-way stretch fabric preferably contains elastane. For use, the two-way stretch fabric is advantageously bonded to the insert.

According to another exemplary embodiment, the insert is positioned in a portion of the region of the tyre that is axially on the inside of the reinforcing structure.

In such an instance, it may for example be positioned under the crown region and/or along at least one of the sidewalls in the radial direction, and/or in at least one axial end of the reinforcing structure, also referred to as shoulder.

According to one advantageous embodiment, the insert is covered with an airtight layer devoid of elastomer composition derived from recycled tyres.

The airtight layer preferably contains over 50 phr of butyl and/or antioxidants such as 6 PPD for example.

### DESCRIPTION OF THE FIGURES

All the embodiment details are given in the following description, which is supplemented by FIGS. 1 to 9b, which are given solely by way of non-limiting examples and in which:

FIG. 1 is a schematic view in cross section of half of an example of a tyre provided with an insert arranged on the axially external region of the sidewall;

FIGS. 2 to 5 are schematic depictions illustrating the insert of the tyre of FIG. 1, covered with different arrangements of protective layers;

FIG. 6 schematically illustrates the insert of FIGS. 2 to 5 before the placement of a protective layer;

FIG. 7 is a schematic depiction of one example of a cross section through a tyre provided with an insert in the vicinity of the cavity of the tyre;

FIG. 8 is a graph illustrating the characteristics of the materials used in order to conduct a comparative test;

FIGS. 9a and 9b schematically illustrate the matrix and the particles of the test specimen used for the comparative test, before deformation (FIG. 9a) and after deformation (FIG. 9b).

### DETAILED DESCRIPTION OF THE INVENTION

### Definitions:

What is meant by the modulus (G*) of a composition is the dynamic shear modulus measured at 23° C. under an alternating shear stress of 0.7 MPa at a frequency of 10 Hz.

For the recycled material composition, the modulus corresponds to the modulus of all of the particles sintered under a pressure of 50 bar, at a temperature of 150° C. for 5′ after having reached the said temperature.

### Insert

The tyre 1 comprises sidewalls 2, a crown region 3 provided with a tread 4 and a reinforcing structure 5 extending between the sidewalls and passing via the crown region.

At least a portion of one of the sidewalls and/or of the crown comprises an insert 6 containing a first elastomer composition acting as a matrix through which a second elastomer composition derived from recycled tyres is distributed, substantially uniformly. The modulus G* of the first composition is at least 10% higher than the modulus G* of the second composition. More preferentially, the modulus G* of the first composition is comprised between 110% and 600% of the modulus G* of the second composition, and even more preferentially between 120% and 250% of the modulus of the second composition.

The matrix is at least in part made up of NR, IR, SBR, BR elastomers or combinations of these elastomers. At the time of manufacture, and particularly prior to the step of moulding the new tyre, this matrix is an elastomer compound in the raw, which means to say uncrosslinked, state. By contrast, the material of the second elastomer composition, derived from recycled tyres, is already crosslinked.

The modulus G* of the first composition is comprised between 1.2 MPa and 10 MPa, and preferentially between 1.4 MPa and 3 MPa

By virtue of these features, the recycled-product content can be particularly high without affecting the properties of the tyre, either in terms of behaviour or in terms of endurance.

The proportion of second composition is greater than or equal to 40% or else greater than or equal to 60%, and even greater than or equal to 80%.

The second elastomer composition has a particle size distribution less than or equal to 1 mm and preferentially less than or equal to 0.5 mm and even more preferentially less than or equal to 0.2 mm of mean diameter of each of the particles.

Furthermore, locally, the stiffness of the first composition is higher than the stiffness of the particles that make up the second composition, at least in the case of 90% of the particles.

Comparative tests and calculations were conducted with two “opposing” scenarios, on the basis of two materials A and B, material B having a stiffness corresponding to twice that of material A. The characteristics of these materials are illustrated using the graph of FIG. 8. The aim of this approach was to accurately determine the mean shear stresses borne at the interface of the particles dispersed in a matrix. Materials A and B were each in turn used as the material of the matrix and as the material of the particles dispersed in this matrix. The table below collates the results obtained.

TABLE 1
surface stresses on the material dispersed in
the matrix for the two opposing scenarios

| | | | Mean surface stress of |
|---|---|---|---|
| | Matrix | Material dispersed | the material dispersed |
| | material | in the matrix | in the matrix |
| Scenario 1 | A = lower | B = higher | 0.7 MPa |
| | stiffness | stiffness | |
| Scenario 2 | B = higher | A = lower | 0.3 MPa |
| | stiffness | stiffness | |

In scenario 1, the test specimen used for the test comprises a matrix of “soft” material A, in which particles of a material B of higher stiffness are dispersed;

In scenario 2, the test specimen used for the test comprises a matrix of “hard” material B, in which particles of a material A of lower stiffness are dispersed.

These comparative tests made it possible to demonstrate that the surface stress borne by the dispersed particles of scenario 2 (0.3 MPa) is markedly lower than the stress borne by the dispersed particles of scenario 1 (0.7 MPa).

These tests indeed confirm that the use of a matrix having a modulus higher than that of the composition derived from recycled tyres which is incorporated therein affords mechanical properties that are markedly more favourable to preserving the particles of the incorporated material and ensuring a better durability of the whole.

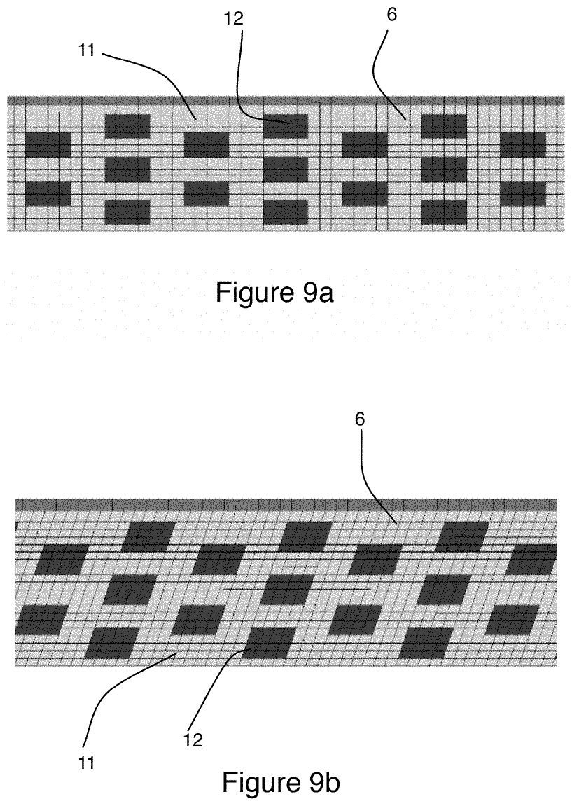

FIGS. 9a and 9b schematically illustrate the matrix 11 and the particles 12 before deformation (FIG. 9a) and after deformation (FIG. 9b).

The weakest region of a compound incorporating integrated particles is found at the interface between the two materials. It is therefore advantageous for these two components to be bound in the most robust possible way and for the stress at the said interface to be reduced. The proposed solution makes it possible greatly to decrease the stress at the interface between the matrix and the particles.

### Design Examples

### External Insert

FIG. 1 is a schematic depiction of a sectional view of an example of a tyre comprising sidewalls 2, and a crown region 3 provided with a tread 4. As illustrated, the tyre provides a reinforcing structure 5 which extends from one sidewall to the other, passing via the crown region 3.

An insert 6 is arranged on at least one sidewall, against the portion axially outside the reinforcing structure 5.

This insert consists of a first elastomer composition serving as a matrix, within which a second elastomer composition derived from recycled tyres is distributed substantially uniformly.

The proportion of second elastomer composition is greater than or equal to 40% and more preferentially greater than 60%.

The second elastomer composition has a particle size distribution less than 1 mm and preferentially less than 0.5 mm and even more preferentially less than 0.2 mm of mean diameter of each of the particles.

A protective layer 7 covers the insert in order to protect it from external attack.

Depending on the intended needs and uses, the protective layer 7 may be produced with a layer of elastomer composition or it may also consist of a two-way stretch fabric, preferentially based on elastane.

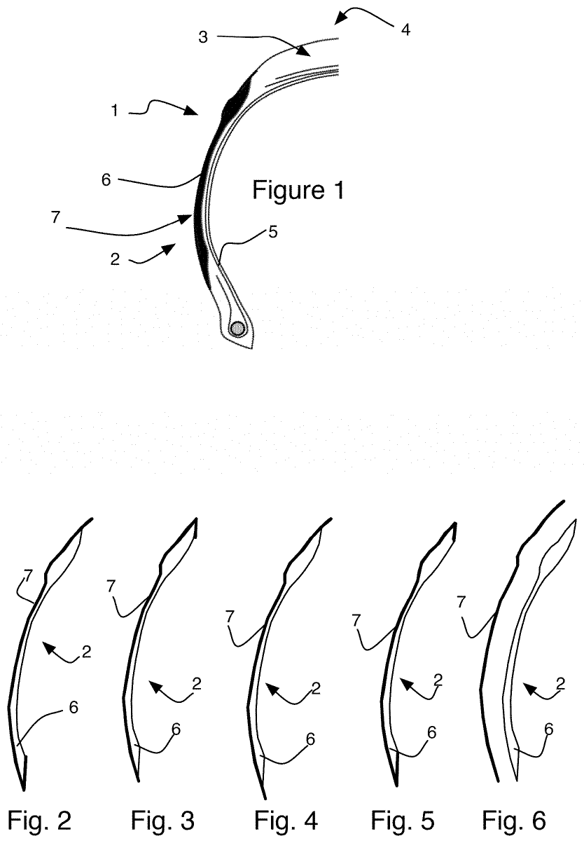

FIGS. 2 to 5 show four exemplary embodiments of sidewall insert with different types of folding of the protective layer against one or both ends of the insert 6. In the example of FIG. 2 and of FIG. 4, the protective layer is arranged to extend beyond the insert. In the examples of FIGS. 2, 3 and 5, the protective layer is folded over so as to pass around at least one of the ends of the insert. The folding makes it possible to encase the radially lower and/or upper end of the insert, for better protection.

In order to manufacture a tyre as described and illustrated above, a process for manufacturing a tyre is provided, comprising a preparatory step in which an insert 6 is pre-fabricated. The protective layer provided (textile or elastomer) is subsequently applied against the part intended to be located on the outside of the tyre, as shown in FIG. 6. In order to facilitate the assembly operations, the protective layer is preferably precoated with adhesive before being applied against the insert. This step is particularly advantageous in the case of the use of a textile layer. In cases in which the protective layer is folded against one or both of the two ends of the insert, the fabric or elastomer layer, with suitable dimensions is simply turned over and applied against the intended region or regions, as illustrated in the different examples of FIGS. 2 to 5.

In the industrial phase, a plurality of inserts are jointly prepared for subsequent assembly.

During the assembly of the different constituents of the tyre, the insert is applied to the region intended to accept the insert, such as, for example, to a sidewall 2 of the tyre being manufactured.

The composite mixture of the raw matrix and of the particles distributed through the matrix is then subjected to a crosslinking reaction. The crosslinking reaction is advantageously a vulcanization.

### Insert in the Vicinity of the Internal Cavity of the Tyre

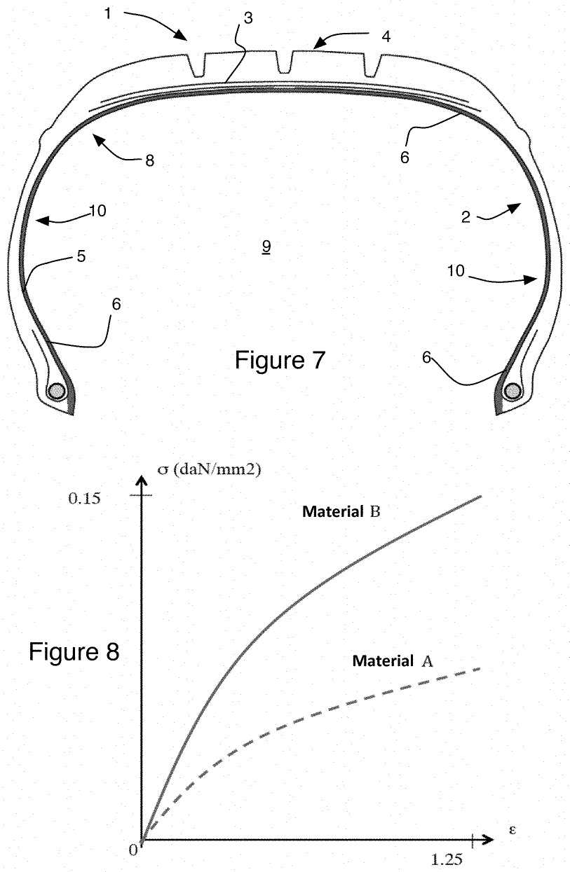

FIG. 7 is a schematic depiction of a sectional view of an example of a tyre comprising sidewalls 2, and a crown region 3 provided with a tread 4. As illustrated, the tyre provides a reinforcing structure 5 which extends from one sidewall to the other, passing via the crown region 3.

At least a portion of the region of the tyre that is axially inside the reinforcing structure 5 comprises an insert 6 arranged in the (direct or indirect) vicinity of the cavity 9 of the tyre.

This insert consists of a first elastomer composition serving as a matrix, within which a second elastomer composition derived from recycled tyres is distributed substantially uniformly.

The proportion of second elastomer composition is greater than or equal to 40% and more preferentially greater than or equal to 60%, and even more preferentially greater than or equal to 80%.

The second elastomer composition has a particle size distribution less than or equal to 1 mm and preferentially less than or equal to 0.5 mm and even more preferentially less than or equal to 0.2 mm of mean diameter of each of the particles.

In the example illustrated, the insert 6 passes through the whole of the inner region of the tyre, from one bead to the other. According to various alternative forms of embodiment, the insert is located in a more restricted portion, such as, for example, in the radial direction in at least one of the sidewalls 2, or along the crown region 3, under the latter, or else in the shoulder region 8 of the tyre.

As illustrated, the insert is covered, on the side of the tyre internal cavity 9, with an airtight layer 10. This layer is devoid of elastomer composition derived from recycled tyres. It advantageously comprises more than 50 phr of butyl. It advantageously comprises antioxidants, such as, for example, 6 PPD.

The insert according to the invention may be used on any type of tyre. Its advantages on tyres for heavy goods vehicles or civil engineering vehicles are appreciable. For example, in the case of civil engineering tyres, the thickness of the insert may be greater than 5 mm and, for some tyre sizes, may reach 8 to 10 mm.

Other shapes, arrangements and/or positionings of inserts are also possible. In one example which has not been illustrated, an inserts provided in the tread of the tyre.

### REFERENCE NUMERALS EMPLOYED IN THE FIGURES

1 Tyre
2 Sidewall
3 Crown region
4 Tread
5 Reinforcing structure
6 Insert
7 Protective layer
8 Shoulder
9 Cavity of the tyre
10 Airtight layer
11. Matrix of elastomer composition
12 Particle of elastomer composition derived from recycled tyres

1.-19. (canceled)

20. A tire including sidewalls, a crown region provided with a tread, and a reinforcing structure extending between the sidewalls and passing via the crown region, at least a portion of one of the sidewalls and/or of the crown comprising an insert comprising a first elastomer composition serving as a matrix, within which a second elastomer composition derived from recycled tires is distributed substantially uniformly,
wherein the dynamic shear modulus G* of the first composition is at least 10% greater than the mean dynamic shear modulus G* of the second composition, and
wherein the proportion of second composition is greater than or equal to 20% of the mass of the insert.

21. The tire according to claim 20, wherein the proportion of second composition is greater than or equal to 25% of the mass of the insert.

22. The tire according to claim 21, wherein the proportion of second composition is greater than or equal to 40% of the mass of the insert.

23. The tire according to claim 20, wherein the dynamic shear modulus G* of the first composition is between 110% and 600% of the dynamic shear modulus G* of the second composition.

24. The tire according to claim 23, wherein the dynamic shear modulus G* of the first composition is between 120% and 250% of the dynamic shear modulus G* of the second composition.

25. The tire according to claim 20, wherein the dynamic shear modulus G*of the first composition is between 1.2 MPa and 10 MPa.

26. The tire according to claim 25, wherein the dynamic shear modulus G*of the first composition is between 1.4 MPa and 3 MPa.

27. The tire according to claim 20, wherein the proportion of second composition is greater than 60% of the mass of the insert.

28. The tire according to claim 27, wherein the proportion of second composition is greater than 80% of the mass of the insert.

29. The tire according to claim 20, wherein the first elastomer composition has a high content of antioxidants.

30. The tire according to claim 20, wherein the first composition is a rubber composition.

31. The tire according to claim 20, wherein the second elastomer composition has a particle size distribution less than or equal to 1 mm of mean diameter of each of the particles.

32. The tire according to claim 31, wherein the second elastomer composition has a particle size distribution less than or equal to 0.5 mm of mean diameter of each of the particles.

33. The tire according to claim 32, wherein the second elastomer composition has a particle size distribution less than or equal to 0.2 mm of mean diameter of each of the particles.

34. The tire according to claim 20, wherein the insert is positioned in the portion of the sidewalls that is axially outside the reinforcing structure.

35. The tire according to claim 34, wherein the insert is covered axially on the outside by a protective layer.

36. The tire according to claim 35, wherein the protective layer is a layer of elastomer composition or a layer made of a two-way stretch fabric.

37. The tire according to claim 36, wherein the two-way stretch fabric is adhesively bonded to the insert.

38. The tire according to claim 20, wherein the insert is positioned in a portion of the region of the tire that is axially inside the reinforcing structure.

39. The tire according to claim 38, wherein the insert is located under the crown region.

40. The tire according to claim 38, wherein the insert is located along at least one of the sidewalls in the radial direction.

41. The tire according to claim 38, wherein the insert is located in at least one axial end of the reinforcing structure.

42. The tire according to claim 38, wherein the insert is covered with an airtight layer devoid of elastomer composition derived from recycled tires.

43. The tire according to claim 42, wherein the airtight layer comprises more than 50 phr of butyl.

44. The tire according to claim 42, wherein the airtight layer comprises antioxidants.
